(19) United States
(12) Patent Application Publication
(10) Pub. No.: US 2023/0282009 A1
(43) Pub. Date: Sep. 7, 2023

(54) COMPUTER-READABLE RECORDING MEDIUM STORING INFORMATION PROCESSING PROGRAM, INFORMATION PROCESSING APPARATUS, AND INFORMATION PROCESSING METHOD

(71) Applicant: Fujitsu Limited, Kawasaki-shi (JP)

(72) Inventor: Kentaro TAKEMOTO, Kawasaki (JP)

(73) Assignee: Fujitsu Limited, Kawasaki-shi (JP)

(21) Appl. No.: 18/089,637

(22) Filed: Dec. 28, 2022

(30) Foreign Application Priority Data
Mar. 3, 2022 (JP) 2022-032885

(51) Int. Cl. G06V 20/70; G06V 10/764

(52) U.S. Cl. CPC G06V 20/70; G06V 10/764; G06V 10/82

(57) ABSTRACT

A computer-readable recording medium stores an information processing program. The program is for causing a computer to execute a process including: generating data in which, to each piece of word information included in a graph that represents a plurality of target objects in image data and a relationship between the plurality of target objects, information that indicates a relationship to which the piece of word information belongs and information that indicates a role of the piece of word information in the relationship are added; acquiring, through machine learning in which the generated data serves as input data to an autoencoder, a feature quantity for the input data; and performing classification of the image data, based on the acquired feature quantity.

### CROSS-REFERENCE TO RELATED APPLICATION

This application is based upon and claims the benefit of priority of the prior Japanese Patent Application No. 2022-32885, filed on Mar. 3, 2022, the entire contents of which are incorporated herein by reference.

### FIELD

The embodiment described herein is related to a computer-readable recording medium storing an information processing program, an information processing apparatus, and an information processing method.

### BACKGROUND

There is a method for identifying a topic related to image data by using a knowledge graph obtained from the image data. To identify the topic, training data is prepared separately from the image data.

Japanese Laid-open Patent Publication No. 2020-57365 is disclosed as related art.

### SUMMARY

According to an aspect of the embodiments, a non-transitory computer-readable recording medium storing an information processing program for causing a computer to execute a process including: generating data in which, to each piece of word information included in a graph that represents a plurality of target objects in image data and a relationship between the plurality of target objects, information that indicates a relationship to which the piece of word information belongs and information that indicates a role of the piece of word information in the relationship are added; acquiring, through machine learning in which the generated data serves as input data to an autoencoder, a feature quantity for the input data; and performing classification of the image data, based on the acquired feature quantity.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram for describing an image-feature-quantity-based clustering process in the related art;

FIG. 2 is a block diagram schematically illustrating an example of a hardware configuration of an information processing apparatus according to an embodiment;

FIG. 3 is a diagram for describing a first example of a feature quantity acquisition process at the time of training performed by the information processing apparatus illustrated in FIG. 2;

FIG. 4 is a diagram schematically illustrating an example of a scene graph in the information processing apparatus illustrated in FIG. 2;

FIG. 5 is a block diagram schematically illustrating an example of a software configuration at the time of training performed by the information processing apparatus illustrated in FIG. 2;

FIG. 6 is a diagram for describing an example of a clustering process at the time of inference performed by the information processing apparatus illustrated in FIG. 2;

FIG. 7 is a diagram for describing another example of the clustering process at the time of inference performed by the information processing apparatus illustrated in FIG. 2;

FIG. 8 is a block diagram schematically illustrating an example of a software configuration at the time of inference performed by the information processing apparatus illustrated in FIG. 2;

FIG. 9 is a diagram for describing an example of a data format conversion process performed in the information processing apparatus illustrated in FIG. 2;

FIG. 10 is a diagram illustrating an example of a training process performed by the information processing apparatus illustrated in FIG. 2;

FIG. 11 is a diagram illustrating another example of the training process performed by the information processing apparatus illustrated in FIG. 2;

FIG. 12 is a diagram for describing a second example of the feature quantity acquisition process at the time of training performed by the information processing apparatus illustrated in FIG. 2;

FIG. 13 is a diagram for describing a third example of the feature quantity acquisition process at the time of training performed by the information processing apparatus illustrated in FIG. 2;

FIG. 14 is a diagram illustrating an example of an abnormality detection process performed in the information processing apparatus illustrated in FIG. 2;

FIG. 15 is a diagram illustrating an example of a summary generation process performed in the information processing apparatus illustrated in FIG. 2;

FIG. 16 is a flowchart for describing the training process performed in the information processing apparatus illustrated in FIG. 2; and

FIG. 17 is a flowchart for describing an inference process performed in the information processing apparatus illustrated in FIG. 2.

### DESCRIPTION OF EMBODIMENTS

In the conventional technology, depending on contents of the prepared training data, the image data may not be classified while reflecting a plurality of target objects in the image data and a relationship between the plurality of target objects.

In one aspect, it is an object to classify image data with a plurality of target objects in the image data and a relationship between the plurality of target objects being reflected.

### [A] Related Example

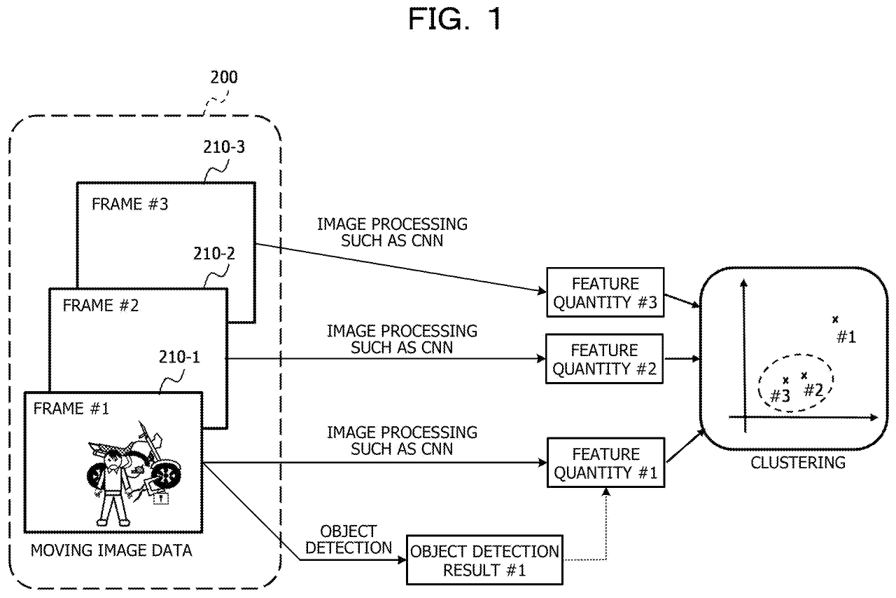

FIG. 1 is a diagram describing a clustering process in the related art. Clustering means classifying pieces of data based on a degree of similarity between the pieces of data. In the process illustrated in FIG. 1, clustering is performed on frame images 210-1 to 210-3 included in moving image data 200, based on feature quantities. The moving image data 200 is an input moving image, and in one example, may be a video image to be monitored or may be a moving image of another type.

In one example, each of the frame images 210-1 to 210-3 (which may be collectively referred to as frame images 210) included in the moving image data 200 is image data. Image processing such as a convolutional neural network (CNN) is performed on each of the input frame images 210, so that respective feature quantities #1 to #3 are obtained. The CNN is a neural network widely used in image processing.

To obtain the feature quantities #1 to #3, an object detection result (for example, an object detection result #1 illustrated in FIG. 1) of a target object may be used in addition to the image processing such as the CNN. A feature quantity obtained from the image data itself such as each of the frame images 210 may be referred to as an “image feature quantity”. The target object may be referred to as an object.

However, in a case where a feature quantity is obtained from each of the frame images 210 themselves, the feature quantity may be affected by a color tone of the image, an imaging angle of the image, and the like. As a result, scene contents such as a target object appearing in the frame image 210, an action of a target object, or a relationship between a plurality of target objects may not be accurately reflected in the feature quantity.

Accordingly, it is expected to include, in input data, a scene graph having a plurality of target objects and relationship information between the plurality of target objects. A scene graph is represented in a data format in which a plurality of sets of a target object serving as a subject, a target object serving as an object, and a relationship between the target objects are linked together. A feature quantity is acquired based on the scene graph in a process according to an embodiment.

### [B] Embodiment

An embodiment will be described below with reference to the drawings. The embodiment described below is merely illustrative and is not intended to exclude employment of various modification examples or techniques that are not explicitly described in the embodiment. For example, the present embodiment may be implemented by variously modifying the embodiment within the scope not departing from the gist of the embodiment. Each of the drawings is not intended to indicate that only elements illustrated therein are included, and other functions or the like may be included.

Since each of the same reference signs denotes substantially the same parts in the drawings, the description thereof is omitted below.

### [B-1] Example of Configuration

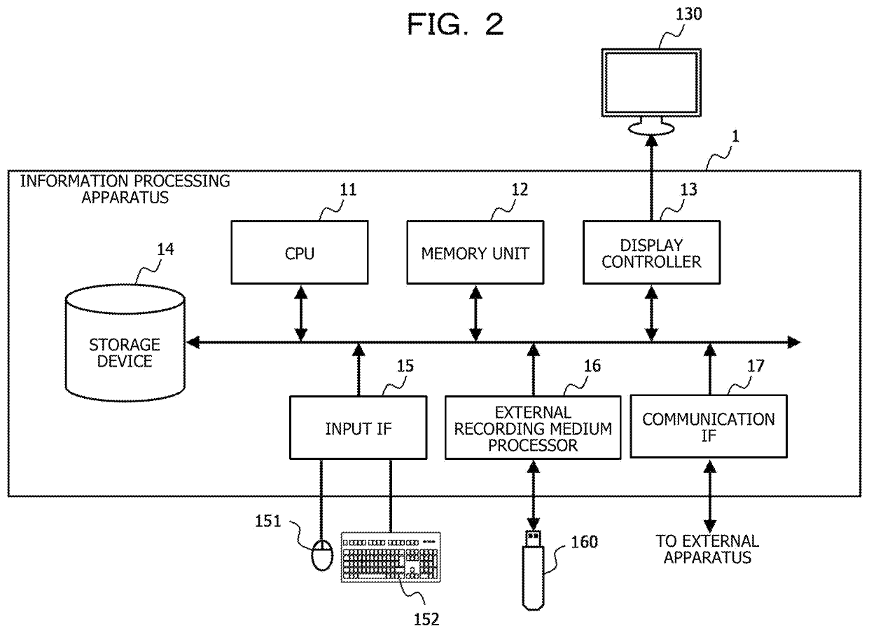

FIG. 2 is a block diagram schematically illustrating an example of a hardware configuration of an information processing apparatus 1 according to the embodiment.

The information processing apparatus 1 is a computer. As illustrated in FIG. 2, the information processing apparatus 1 includes a central processing unit (CPU) 11, a memory unit 12, a display controller 13, a storage device 14, an input interface (IF) 15, an external recording medium processor 16, and a communication IF 17.

The memory unit 12 is an example of a storage unit and includes, for example, a read-only memory (ROM), a random-access memory (RAM), and the like. A program such as a Basic Input/Output System (BIOS) may be written in the ROM of the memory unit 12. A software program in the memory unit 12 may be appropriately loaded and executed by the CPU 11. The RAM of the memory unit 12 may be used as a temporary recording memory or as a working memory.

The display controller 13 is coupled to a display device 130 and controls the display device 130. The display device 130 is a liquid crystal display, an organic light-emitting diode (OLED) display, a cathode ray tube (CRT) display, an electronic paper display, or the like and displays various kinds of information for an operator or the like. The display device 130 may be a device combined with an input device. For example, the display device 130 may be a touch panel.

The storage device 14 is a storage device having high input/output (IO) performance. For example, a dynamic random-access memory (DRAM), a solid-state drive (SSD), a storage class memory (SCM), or a hard disk drive (HDD) may be used as the storage device 14.

The input IF 15 may be coupled to input devices such as a mouse 151 and a keyboard 152 and control the input devices such as the mouse 151 and the keyboard 152. The mouse 151 and the keyboard 152 are an example of the input devices. The operator performs various input operations via these input devices.

The external recording medium processor 16 is configured so that a recording medium 160 is attachable thereto. The external recording medium processor 16 is configured to be able to read information recorded in the recording medium 160 in a state in which the recording medium 160 is attached thereto. In this example, the recording medium 160 has portability. For example, the recording medium 160 is a flexible disk, an optical disk, a magnetic disk, a magneto-optical disk, a semiconductor memory, or the like.

The communication IF 17 is an interface that enables communication with an external apparatus.

The CPU 11 is an example of a processor and is a processing device that performs various controls and operations. By executing an operating system (OS) and a program loaded into the memory unit 12, the CPU 11 implements various functions.

The device that controls the operations of the entire information processing apparatus 1 is not limited to the CPU 11 and may be, for example, any one of an MPU, a DSP, an ASIC, a PLD, and an FPGA. The device that controls the operations of the entire information processing apparatus 1 may be a combination of two or more types of a CPU, an MPU, a DSP, an ASIC, a PLD, and an FPGA. “MPU” is an acronym for “micro-processing unit”. “DSP” is an acronym for “digital signal processor”. “ASIC” is an acronym for “application-specific integrated circuit”. The PLD is an acronym for “programmable logic device”. The FPGA is an acronym for “field-programmable gate array”.

### [B-1-1] At Time of Training

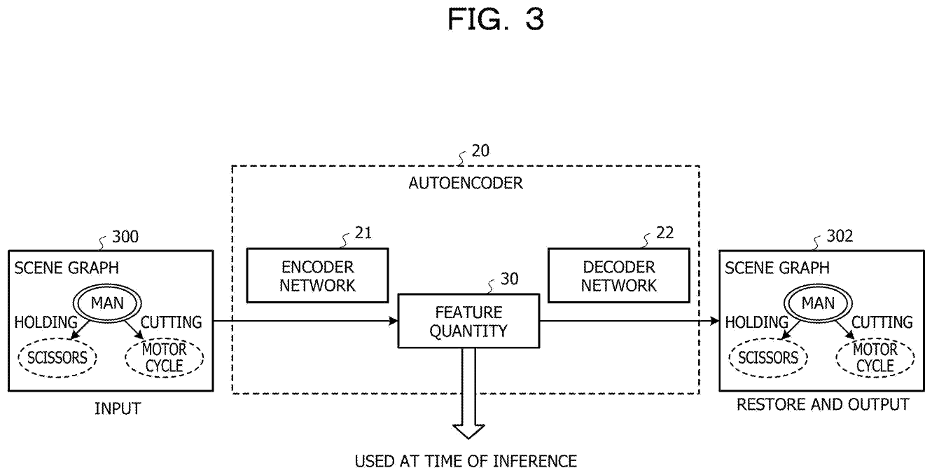

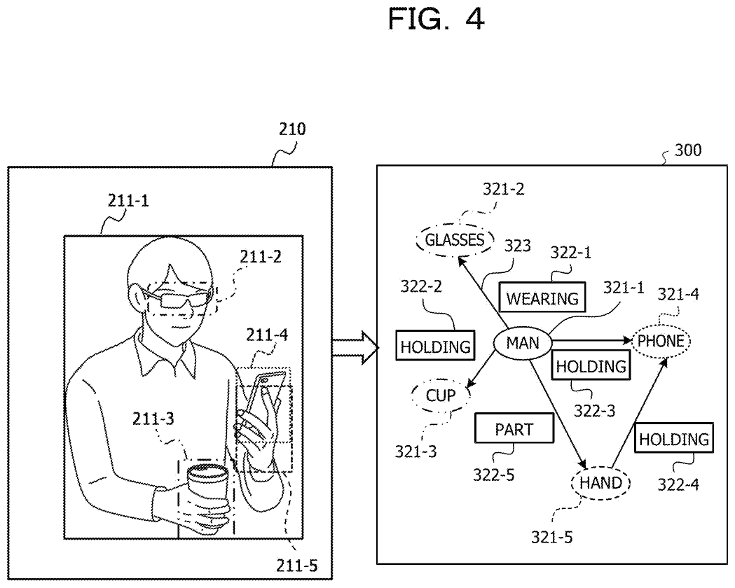

FIG. 3 is a diagram for describing a first example of a feature quantity acquisition process at the time of training performed by the information processing apparatus 1 illustrated in FIG. 2. FIG. 4 is a diagram schematically illustrating an example of a scene graph 300 in the information processing apparatus 1 illustrated in FIG. 2.

As illustrated in FIG. 3, the information processing apparatus 1 inputs the scene graph 300 to an autoencoder 20, and restores and outputs a scene graph 302.

FIG. 4 illustrates the scene graph 300 and the frame image 210 that is a source of the scene graph 300. A plurality of target objects 211-1 to 211-5 (which may be collectively referred to as target objects 211) are included in the frame image 210. In this example, the target objects 211 may be a person (the target object 211-1), may be objects such as glasses (the target object 211-2), a cup (the target object 211-3), and a mobile phone (the target object 211-4), and may be a part such as a hand (the target object 211-5) of a person or an object.

The scene graph 300 is a graph including the plurality of target objects 211 recognized in the frame image 210 and relationships between the plurality of target objects 211. The scene graph 300 may be a graph in which the plurality of target objects 211 recognized in the frame image 210 and the relationships between the plurality of target objects 211 are represented by a tree structure. A scene graph may be one type of a knowledge graph. A graph is a data structure representing vertices (nodes) and relationships between the vertices.

The scene graph 300 may include pieces of first word information 321-1 to 321-5 (which may be collectively referred to as pieces of first word information 321) corresponding to the respective names of the target objects 211. The scene graph 300 may include pieces of second word information 322-1 to 322-4 (which may be collectively referred to as pieces of second word information 322) indicating respective actions of the target objects 211, and may include a piece of third word information 322-5 indicating a state or a situation other than the actions of the target objects 211.

In the scene graph 300, the relationships between the plurality of target objects 211 may be indicated by respective directed edges 323. The directed edges 323 may be lines with arrow heads. To simplify the description, the reference sign is illustrated only for the directed edge 323 between the piece of first word information 321-1 and the piece of first word information 321-2 in FIG. 4. A link relationship between both ends of the directed edge 323 indicates a relationship to which the plurality of pieces of first word information 321 belong, and a direction of the directed edge 323 indicates roles of the plurality of pieces of first word information 321.

In FIG. 3, the information processing apparatus 1 generates converted data by adding information that indicates a relationship and information that indicates a role to each piece of word information included in the scene graph 300. The generated converted data may be data obtained by converting the data format of the scene graph 300.

The information processing apparatus 1 acquires, through machine learning in which the generated converted data serves as input data to the autoencoder 20, a feature quantity 30 for the input data. The machine learning may be self-supervised machine learning. The autoencoder 20 includes an encoder network 21 and a decoder network 22. Each of the encoder network 21 and the decoder network 22 is a neural network.

The encoder network 21 converts input data corresponding to the scene graph 300 into the feature quantity 30. The decoder network 22 restores output data corresponding to the scene graph 302 from the feature quantity 30.

The information processing apparatus 1 adjusts the autoencoder 20 such that the output data matches the input data. For example, the information processing apparatus 1 compares the output data with the input data and calculates a restoration error. The restoration error may be a difference between the input data to the encoder network 21 and the output data from the decoder network 22. The information processing apparatus 1 adjusts, through error back propagation, weights of the two neural networks that are the encoder network 21 and the decoder network 22. Since the feature quantity 30 is a feature quantity encoded between the encoder network 21 and the decoder network 22, the feature quantity 30 may be referred to as an intermediate feature quantity.

The autoencoder 20 trains vectorization models in the two neural networks that are the encoder network 21 and the decoder network 22 so as to be able to restore the target objects 211 and the relationships.

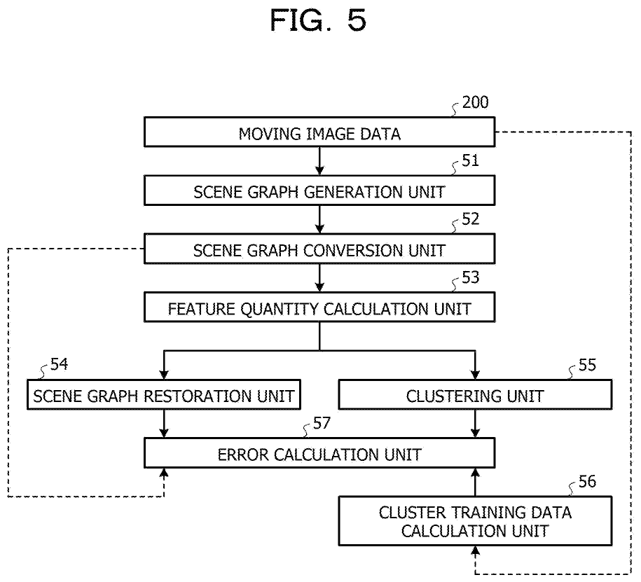

FIG. 5 is a block diagram schematically illustrating an example of a software configuration at the time of training performed by the information processing apparatus 1 illustrated in FIG. 2.

The processor such as the CPU 11 of the information processing apparatus 1 (computer) executes the OS and the program to function as a scene graph generation unit 51, a scene graph conversion unit 52, a feature quantity calculation unit 53, a scene graph restoration unit 54, a clustering unit 55, a cluster training data calculation unit 56, and an error calculation unit 57.

From each of the frame images 210 included in the input moving image data 200, the scene graph generation unit 51 generates the scene graph 300 of the frame image 210. The scene graph generation unit 51 recognizes the target objects 211 included in the frame image 210 and the relationships by using an image processing technique such as a CNN. Each of the target objects 211 is displayed based on coordinates of the target object 211 in the image and a label (such as “man” or “mobile phone”). Since the function of the scene graph generation unit 51 may be implemented by using an existing technique, the detailed description thereof is omitted. The information processing apparatus 1 may acquire the scene graph 300 generated by another apparatus. In this case, the scene graph generation unit 51 may be omitted.

The scene graph conversion unit 52 converts the scene graph 300 into a format that may be input to and output from the autoencoder 20. The feature quantity calculation unit 53 corresponds to the encoder network 21 described above by using FIG. 3. The scene graph restoration unit 54 corresponds to the decoder network 22 described above by using FIG. 3.

The clustering unit 55 reduces a distance between the individual feature quantities 30 acquired based on the respective scene graphs 300 corresponding to the plurality of frame images 210 classified into an identical scene. The clustering unit 55 may increase a distance between the individual feature quantities 30 acquired based on the respective scene graphs 300 corresponding to the plurality of frame images 210 classified into different scenes. In one example, a K-mean method, an expectation-maximization (EM) algorithm, a method using a generative adversarial network (GAN), or the like may be used as the clustering method. The detailed description of the K-mean method, the EM algorithm, and the GAN is omitted.

The cluster training data calculation unit 56 creates training data for the clustering unit 55. In one example, in a case where a distance between the feature quantities 30 is calculated, the cluster training data calculation unit 56 sets “0” when the scene graphs 300 for which the respective feature quantities 30 are calculated are an identical scene, and sets “1” when the scene graphs 300 for which the respective feature quantities 30 are calculated are different scenes. Note that the clustering unit 55 and the cluster training data calculation unit 56 may be omitted.

The error calculation unit 57 may compare the input data created by the scene graph conversion unit 52 and input to the feature quantity calculation unit 53 with the output data restored by the scene graph restoration unit 54 and calculate a scene graph restoration error. The error calculation unit 57 may calculate a clustering error that is an error between a calculation result obtained by the clustering unit 55 and the training data created by the cluster training data calculation unit 56. The error calculation unit 57 may calculate an error by adding the scene graph restoration error and the clustering error together. The error calculated by the error calculation unit 57 is fed back to the feature quantity calculation unit 53 and the scene graph restoration unit 54 by error back propagation. Based on the error, the feature quantity calculation unit 53 and the scene graph restoration unit 54 are adjusted such that the error decreases. The error calculated by the error calculation unit 57 may be further fed back to the clustering unit 55.

### [B-1-2] At Time of Inference

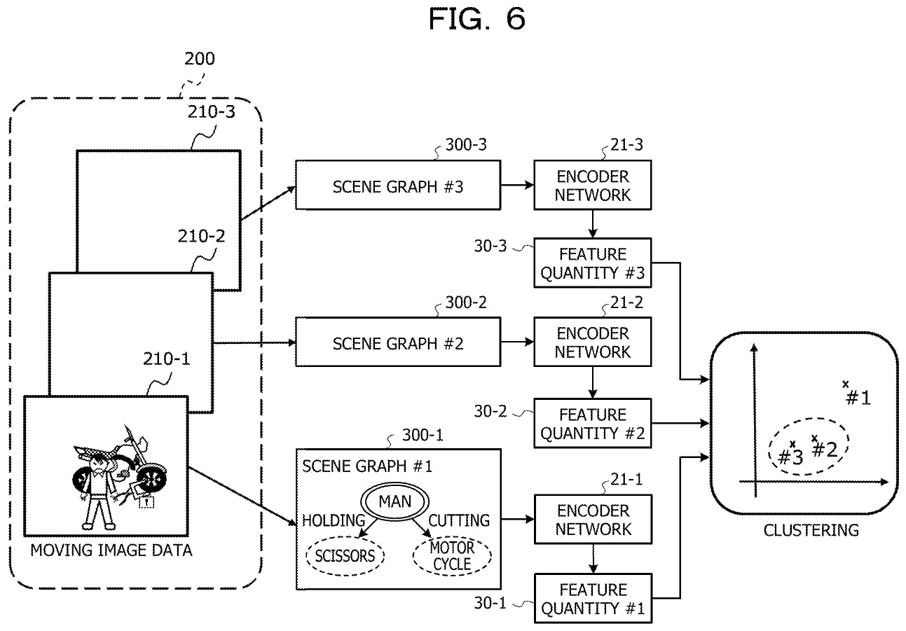

FIG. 6 is a diagram for describing an example of a clustering process at the time of inference performed by the information processing apparatus 1 illustrated in FIG. 2.

With substantially the same method as that used in the processing performed by the scene graph generation unit 51, scene graphs 300-1 to 300-3 are generated from the respective frame images 210-1 to 210-3 included in the moving image data 200. By using trained encoder networks 21-1 to 21-3, feature quantities 30-1 to 30-3 corresponding to the respective scene graphs 300-1 to 300-3 are calculated from the scene graphs 300-1 to 300-3, respectively.

In the example illustrated in FIG. 6, the information processing apparatus 1 inputs the scene graphs 300-1, 300-2, and 300-3 generated from the respective frames to the respective encoder networks 21-1, 21-2, and 21-3 to calculate the feature quantities 30-1, 30-2, and 30-3, respectively.

By using the feature quantities 30-1 to 30-3, the information processing apparatus 1 performs clustering (classification) on the frame images 210-1 to 210-3. In the example illustrated in FIG. 6, based on the feature quantities 30-1 to 30-3, a frame #2 and a frame #3 are classified into an identical group, and a frame #1 is classified into a group different from that of the frame #2 and the frame #3.

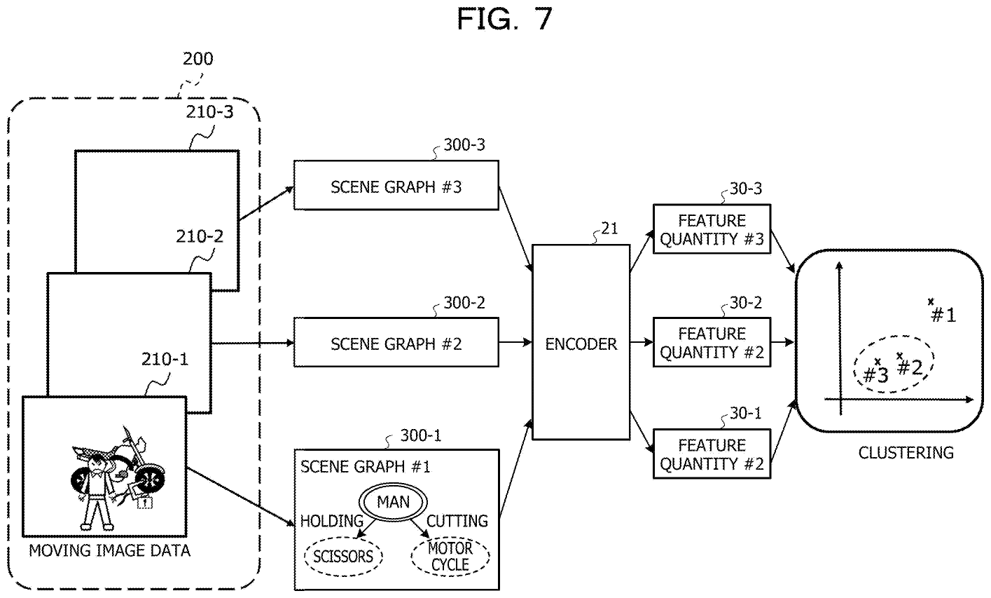

FIG. 7 is a diagram for describing another example of the clustering process at the time of inference performed by the information processing apparatus 1 illustrated in FIG. 2.

In the example illustrated in FIG. 7, the information processing apparatus 1 inputs the scene graphs 300-1, 300-2, and 300-3 generated from the plurality of frame images 210-1 to 210-3 to the single encoder network 21 to calculate the feature quantities 30-1 to 30-3. Thus, the information as the moving image is reflected in the feature quantities 30-1 to 30-3.

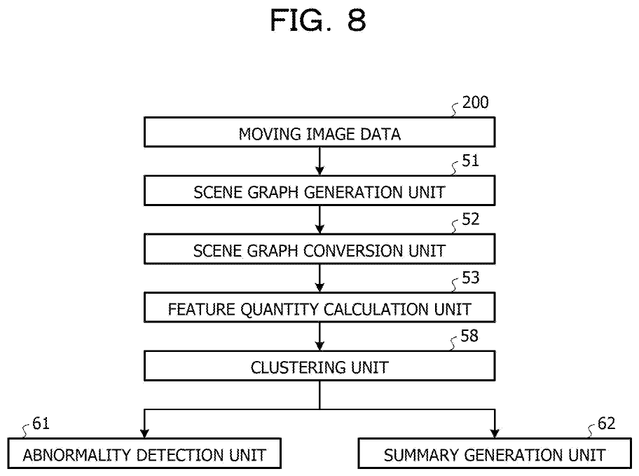

FIG. 8 is a block diagram schematically illustrating an example of a software configuration at the time of inference performed by the information processing apparatus 1 illustrated in FIG. 2.

The processor such as the CPU 11 of the information processing apparatus 1 (computer) executes the OS and the program to function as the scene graph generation unit 51, the scene graph conversion unit 52, the feature quantity calculation unit 53, a clustering unit 58, an abnormality detection unit 61, and a summary generation unit 62.

The scene graph generation unit 51, the scene graph conversion unit 52, and the feature quantity calculation unit 53 perform substantially the same processing as that performed at the time of training illustrated in FIG. 5.

Based on the acquired feature quantities 30, the clustering unit 58 performs clustering of the pieces of image data. The feature quantities 30 are calculated by the feature quantity calculation unit 53. The clustering unit 58 may perform clustering on the pieces of image data in accordance with the distance between the feature quantities 30. The clustering may be performed by using an existing clustering method. In one example, a K-mean method, an EM algorithm, a method using a GAN, or the like may be used as the clustering method. The detailed description of the K-mean method, the EM algorithm, and the GAN is omitted.

The abnormality detection unit 61 detects a frame image #n corresponding to a time series when an abnormality has occurred. The abnormality detection unit 61 may detect an abnormality by using an existing outlier detection method. An outlier may be a value of which a data point is greatly deviated from the distribution, for example, a value that is markedly separate from other pieces of data.

The summary generation unit 62 generates a summary of the moving image based on a clustering result. Details of the abnormality detection unit 61 and the summary generation unit 62 will be described later. Note that the abnormality detection unit 61 and the summary generation unit 62 may be omitted.

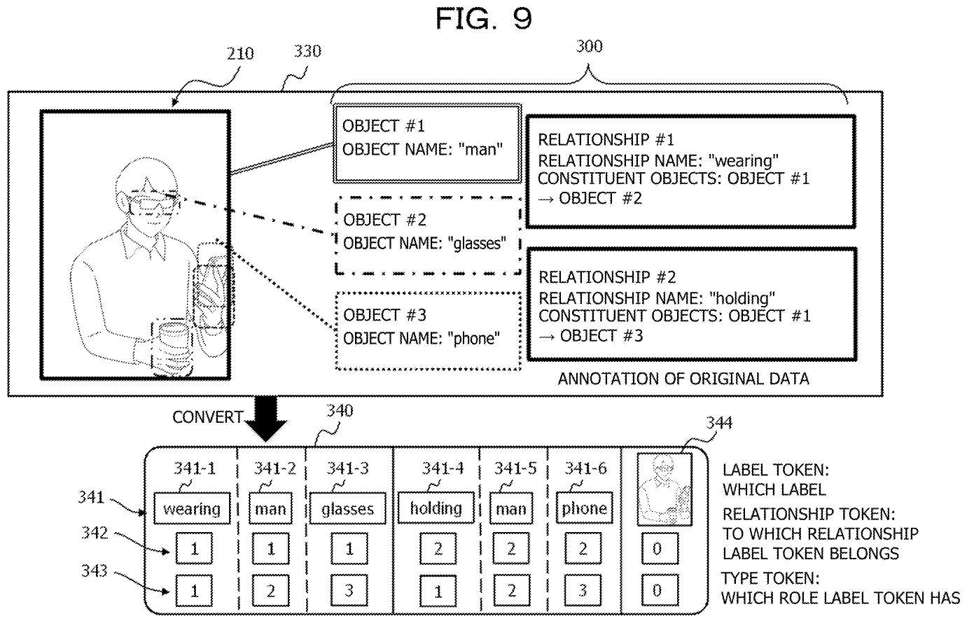

FIG. 9 is a diagram for describing an example of a data format conversion process performed in the information processing apparatus 1 illustrated in FIG. 2. Functions of the scene graph conversion unit 52 illustrated in FIGS. 5 and 8 will be described with reference to FIG. 9.

Original data 330 includes at least the scene graph 300. The original data 330 may be a dataset including the frame image 210 and the scene graph 300 corresponding to the frame image 210. The dataset may be acquired with Visual Genome or the like. The scene graph 300 may be written as an annotation that gives related information to a frame image.

The scene graph conversion unit 52 generates converted data 340 in which, to each piece of word information included in the scene graph 300, information that indicates a relationship to which the piece of word information belongs and information that indicates a role of the piece of word information in the relationship are added. The converted data 340 includes a label token 341 corresponding to a piece of word information included in the scene graph 300, a relationship token 342 indicating a relationship to which the label token belongs, and a type token 343 indicating a role of the label token in the relationship.

The label token 341 is an example of a piece of word information included in the scene graph 300. The label token 341 indicates a class for each instance. An instance includes a target object (object) and a relationship.

The relationship token 342 indicates a relationship to which each instance belongs. The relationship token 342 is an example of information that indicates a relationship to which the piece of word information belongs.

The type token 343 indicates a role played by each instance in the relationship. The type token 343 includes subject information (indicated by “2” in the drawing), object information (indicated by “3” in the drawing), and action information (indicated by “1” in the drawing). The type token 343 is an example of information that indicates a role of the label token in the relationship.

As described above by using FIG. 4, the pieces of word information included in the scene graph 300, for example, instances may include the pieces of first word information 321-1 to 321-5 corresponding to the respective names of the target objects 211, the pieces of second word information 322-1 to 322-4 indicating the respective actions of the target objects 211, and the piece of third word information 322-5 indicating a state or a situation other than the actions of the target objects 211. The label token 341 may be a word itself or may be trained embedding. The trained embedding may be a vector that is a feature quantity indicating a meaning of a word or a sentence with which training is performed in advance in a generic context or the like.

As illustrated in FIG. 9, as the label token 341, there are a label token 341-1 (“wearing”), a label token 341-2 (“man”), a label token 341-3 (“glasses”), a label token 341-4 (“holding”), a label token 341-5 (“man”), and a label token 341-6 (“phone”). The relationship token 342 indicates that the label token 341-1 (“wearing”), the label token 341-2 (“man”), and the label token 341-3 (“glasses”) belong to one relationship (“1”). Likewise, the relationship token 342 indicates that the label token 341-4 (“holding”), the label token 341-5 (“man”), and the label token 341-6 (“phone”) belong to one relationship (“2”).

The type token 343 may include subject information (“2”) that indicates that the label token 341-2 (“man”) corresponds to the subject, object information (“3”) that indicates that the label token 341-3 (“glasses”) corresponds to the object, and action information (“1”) that indicates that the label token 341-1 (“wearing”) corresponds to the action from the subject to the object in the one relationship.

By performing image processing such as a CNN on each piece of image data, the information processing apparatus 1 may perform processing of acquiring an image feature quantity 344 of the piece of image data. The converted data 340 may further include the image feature quantity 344.

In this example, the image feature quantity 344 is distinguishable from the other label tokens 341 because both the relationship token 342 and the type token 343 are set to “0”. As illustrated in FIG. 9, data created from the scene graph 300 and the image feature quantity 344 may be linked together to be the converted data 340. In this case, not only the converted data 340 obtained by converting the data format of the scene graph 300 but also the image feature quantity 344 are input to the autoencoder 20. Data created from the scene graph 300 without including the image feature quantity 344 may be treated as the converted data 340.

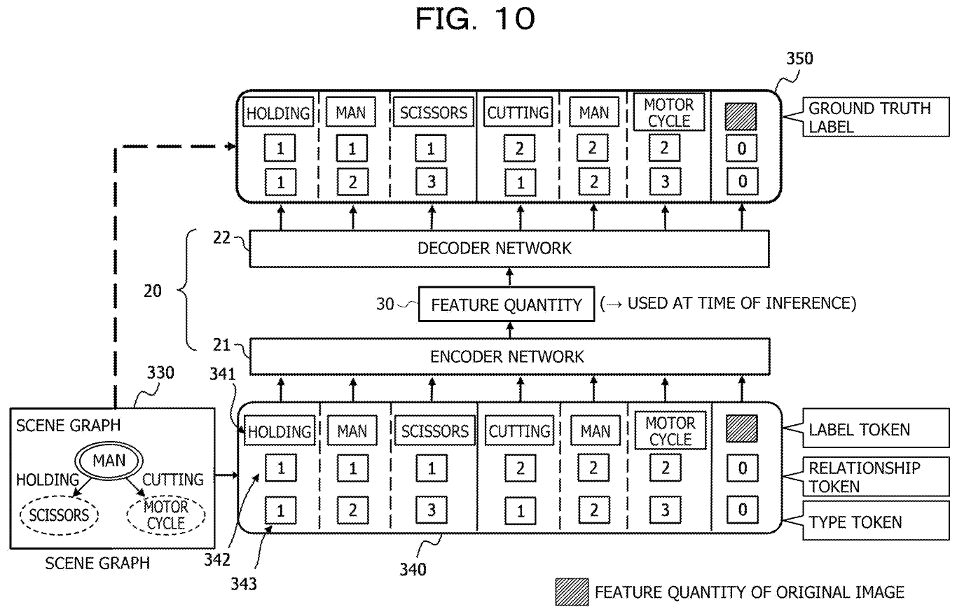

FIG. 10 is a diagram illustrating an example of a training process performed by the information processing apparatus 1 illustrated in FIG. 2.

The converted data 340 that is input data to the autoencoder 20 and output data 350 each include the label token 341, the relationship token 342, and the type token 343. For example, the converted data 340 (input data) input to the encoder network 21 is given as a ground truth label. The encoder network 21 and the decoder network 22 are adjusted such that the output data output from the decoder network 22 matches the ground truth label. For example, the information processing apparatus 1 performs self-supervised machine learning in which the generated converted data 340 serves as the input data to the autoencoder 20.

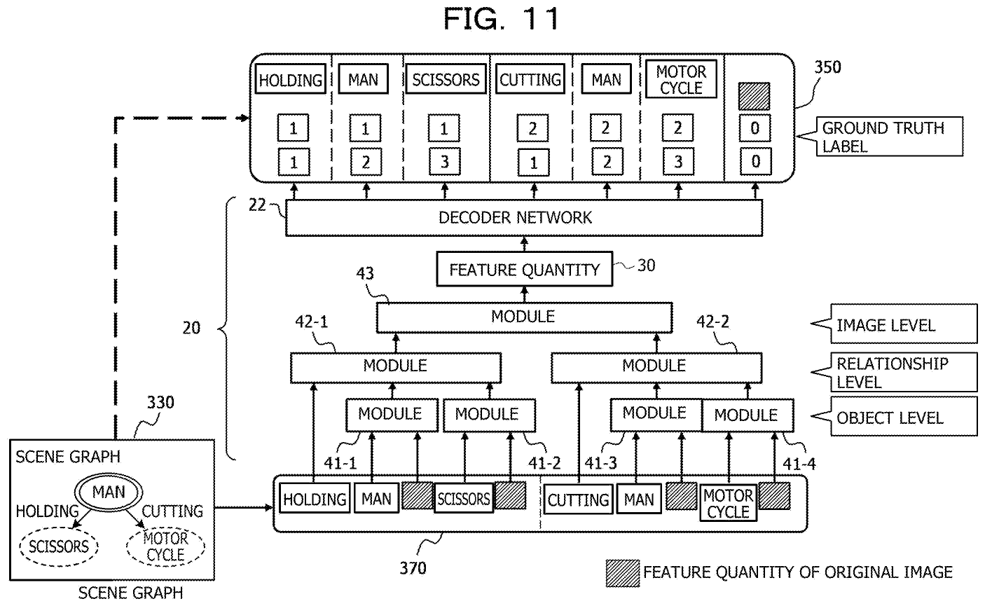

FIG. 11 is a diagram illustrating another example of the training process performed by the information processing apparatus 1 illustrated in FIG. 2.

In the example illustrated in FIG. 11, the encoder network 21 of the autoencoder 20 is not a single neural network but includes a plurality of modules 41, 42, and 43. Each of the modules 41, 42, and 43 is a neural network.

First encoders 41-1 to 41-4 (which may be collectively referred to as first encoders 41) perform first encoding processing of acquiring a piece of word information for one target object among the plurality of target objects 211. In this example, a piece of word information for one target object among the plurality of target objects and the image feature quantity are input to each of the first encoders 41. Each of the first encoders 41 calculates, through machine learning, a first feature quantity in which the piece of word information and the image feature quantity are reflected.

Based on a result of the first encoding processing, second encoders 42-1 and 42-2 (which may be collectively referred to as second encoders 42) perform second encoding processing of acquiring information that indicates a relationship and information that indicates a role. In this example, the result of the first encoding processing performed by each of the plurality of first encoders 41 and a piece of word information that indicates an action or state of the target object 211 are input to each of the second encoders 42. Each of the second encoders 42 calculates, through machine learning, a second feature quantity in which the piece of word information, the information that indicates the relationship, and the information that indicates the role are reflected.

A third encoder 43 performs third encoding processing of acquiring the feature quantity 30 by using data generated based on the first encoding processing and the second encoding processing. In this example, the plurality of second feature quantities generated based on the first encoding processing and the second encoding processing are input to the third encoder 43.

In this example, through the encoding processing performed by the first encoders 41 and the second encoders 42, the second feature quantities are generated as data in which, to each piece of word information included in the scene graph 300, information that indicates a relationship to which the piece of word information belongs and information that indicates a role of the piece of word information in the relationship are added.

The information processing apparatus 1 may compare the output data 350 restored from the feature quantity 30 by the decoder network 22 with data included in the original data 330 input to the first encoders 41 and the second encoders 42 and calculate a restoration error. The information processing apparatus 1 adjusts at least the third encoder 43 and the decoder network 22, and preferably further adjusts the first encoders 41 and the second encoders 42 through error back propagation.

According to the process illustrated in FIG. 11, the encoder network 21 is modularized. Thus, the relationship token and the type token do not have to be added to input data 370. Therefore, the input to the neural network is simplified and training becomes easier.

Since lengths of the inputs to the first encoders 41, the second encoders 42, and the third encoder 43 are limited, training also becomes easier. In the process illustrated in FIG. 11, the decoder network 22 is a single neural network. However, the decoder network 22 may also have a plurality of hierarchical modules like the encoder network illustrated in FIG. 11 instead of the single neural network.

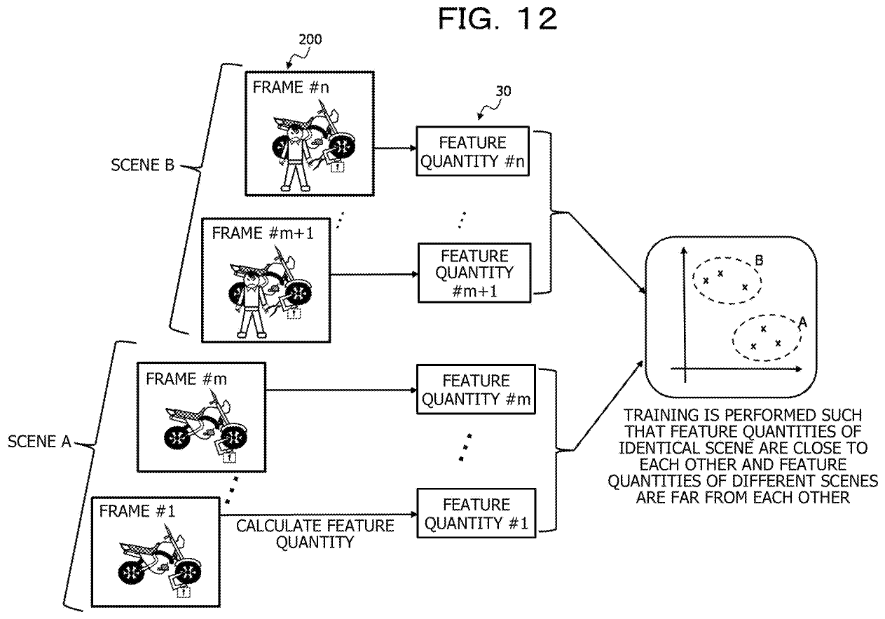

FIG. 12 is a diagram for describing a second example of the feature quantity acquisition process at the time of training performed by the information processing apparatus 1 illustrated in FIG. 2.

In FIG. 12, the moving image data 200 includes a plurality of frame images #1, . . . , #m, #m+1, . . . , #n. The moving image data 200 is segmented (grouped) for each scene. In the example illustrated in FIG. 12, the plurality of frame images are classified into a scene A and a scene B.

The information processing apparatus 1 reduces a distance between feature quantities #1 to #m acquired based on the respective scene graphs 300 corresponding to the plurality of frame images #1 to #m classified into the identical scene A, respectively. The information processing apparatus 1 reduces a distance between feature quantities #m+1 to #n acquired based on the respective scene graphs 300 corresponding to the plurality of frame images #m+1 to #n classified into the identical scene B. By contrast, the information processing apparatus 1 increases a distance between the feature quantities #1 to #m corresponding to the scene A and the feature quantities #m+1 to #n corresponding to the scene B different from the scene A.

In the process illustrated in FIG. 12, for the feature quantities #1 to #n, data is generated in which, to each piece of word information included in the scene graph 300, information that indicates a relationship and information that indicates a role are added. An existing method may be employed except for the processing of acquiring a feature quantity for the input data through machine learning in which the generated data serves as the input data. Examples of the existing method include a K-mean method, an EM algorithm, and GAN. The detailed description of the K-mean method, the EM algorithm, and the GAN is omitted.

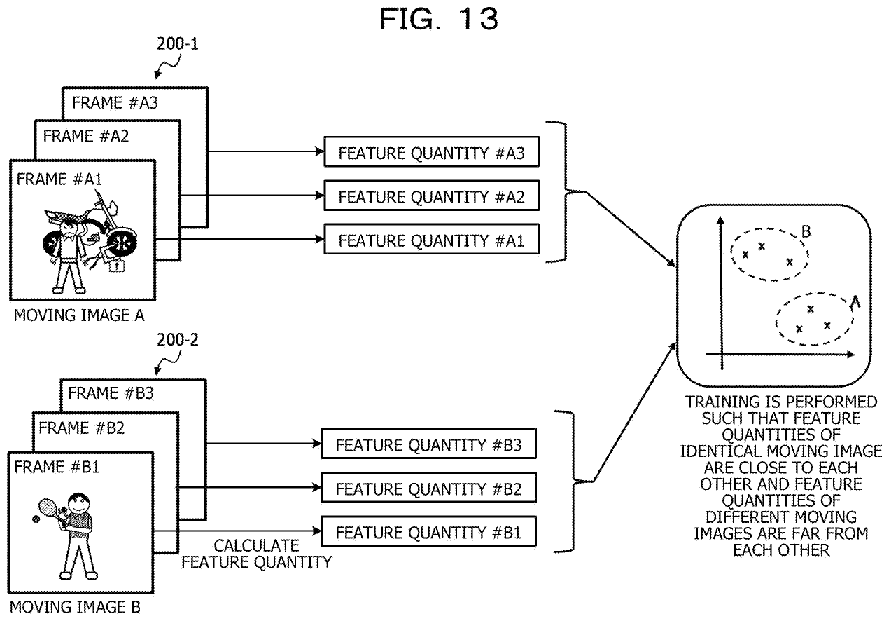

FIG. 13 is a diagram for describing a third example of the feature quantity acquisition process at the time of training performed by the information processing apparatus 1 illustrated in FIG. 2.

In FIG. 13, the moving image data 200 includes a plurality of pieces of moving image data 200-1 (moving image A) and 200-2 (moving image B). The information processing apparatus 1 reduces a distance between individual feature quantities #A1 to #A3 acquired based on the respective scene graphs 300 corresponding to a plurality of frame images #A1 to #A3 included in the identical moving image A. The information processing apparatus 1 reduces a distance between individual feature quantities #B1 to #B3 acquired based on the respective scene graphs 300 corresponding to a plurality of frame images #B1 to #B3 included in the identical moving image B.

The information processing apparatus 1 increases a distance between the feature quantities #A1 to #A3 corresponding to the plurality of frame images #A1 to #A3 included in the moving image A and the feature quantities #B1 to #B3 corresponding to the plurality of frame images #B1 to #B3 included in the moving image B different from the moving image A. The other processing contents are substantially the same as those in the case illustrated in FIG. 12. As described above, even in a case where the moving image data 200 is not segmented, when there is a combination of different moving images, the accuracy of clustering may be improved by pseudo labeling.

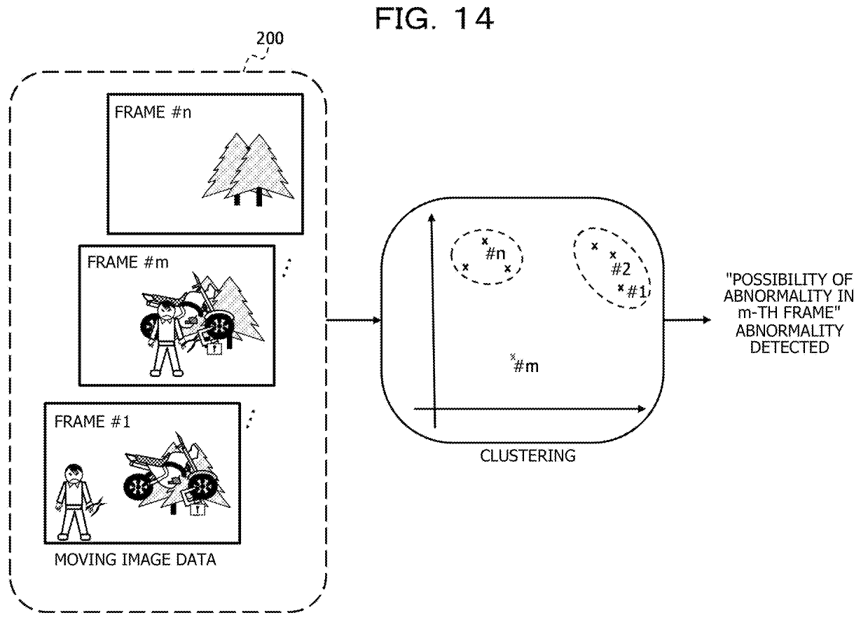

FIG. 14 is a diagram illustrating an example of an abnormality detection process performed in the information processing apparatus 1 illustrated in FIG. 2.

The abnormality detection process is one of application examples using image data division processing. Contents of the process performed by the abnormality detection unit 61 illustrated in FIG. 8 will be described in FIG. 14.

The information processing apparatus 1 performs processing of detecting a time series corresponding to a frame image #m in which an abnormality has occurred, based on distances between the plurality of feature quantities #1, #2, . . . , #m, . . . , #n acquired based on the respective scene graphs 300 corresponding to the plurality of frame images #1, #2, . . . , #m, . . . , #n. For example, the information processing apparatus 1 identifies the frame image #m in which an abnormality has occurred in the moving image data 200. In one example, the information processing apparatus 1 may identify time information that indicates the frame image #m. An existing outlier detection method may be used in the process illustrated in FIG. 14.

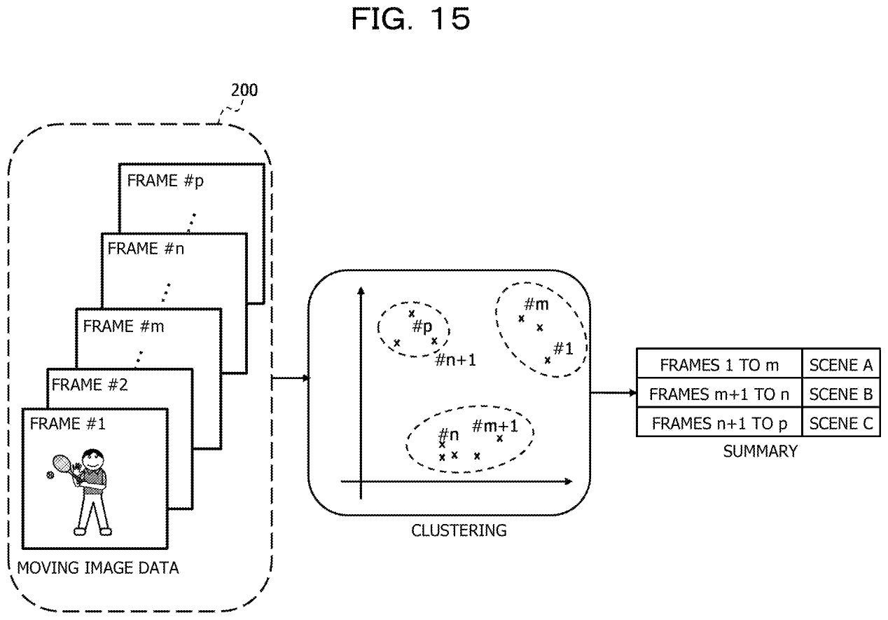

FIG. 15 is a diagram illustrating an example of a summary generation process performed in the information processing apparatus 1 illustrated in FIG. 2.

The summary generation process is one of application examples using image data division processing. Contents of the process performed by the summary generation unit 62 illustrated in FIG. 8 will be described in FIG. 15. The summary generation unit 62 generates a summary of the moving image data 200. The summary is also referred to as a moving image summary. The summary may be data obtained by classifying moving image contents in time series in the moving image data 200. In one example, the summary may be obtained by shortening the length of the video while grasping the basic contents in the original video.

The information processing apparatus 1 obtains a plurality of feature quantities #1, #2, . . . , #m, . . . , #n, . . . , #p acquired based on the respective scene graphs 300 corresponding to a plurality of frame images #1, #2, . . . , #m, . . . , #n, . . . , #p. Based on the plurality of feature quantities #1, #2, . . . , #m, . . . , #n, . . . , #p, the information processing apparatus 1 performs clustering processing on the plurality of frame images #1, #2, . . . , #m, . . . , #n, . . . , #p. As a result, among the plurality of frame images, a first frame (#1) to an m-th frame (#m) are clustered into a scene A. An (m+1)-th frame (#m+1) to an n-th frame (#n) are clustered into a scene B. An (n+1)-th frame (#n+1) to a p-th frame (#p) are clustered into a scene C. The information processing apparatus 1 performs the process of creating a moving image summary (summary) in which moving image contents are summarized in time series by using time information on transitions of scenes A, B, and C obtained based on a clustering result.

### [B-2] Operation Example

### [B-2-1] At Time of Training

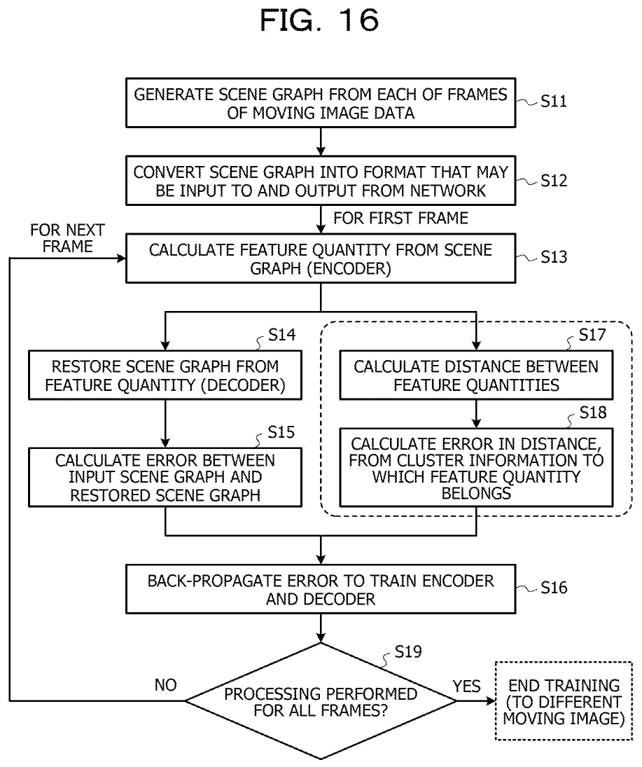

The training process performed in the information processing apparatus 1 illustrated in FIG. 2 will be described in accordance with a flowchart (steps S11 to S19) illustrated in FIG. 16.

The scene graph generation unit 51 generates the scene graph 300 from each of the frame images 210 included in the input moving image data 200 (step S11).

The scene graph conversion unit 52 converts the scene graph 300 into a format that may be input to and output from the autoencoder 20 (step S12). The processing in step S12 is an example of processing of generating data in which, to each piece of word information included in the scene graph 300, information that indicates a relationship and information that indicates a role are added.

For the first frame image 210, the encoder network 21 calculates the feature quantity 30 from the scene graph 300 (step S13). In one example, the encoder network 21 converts the data generated in step S12 for the scene graph 300 into the feature quantity 30.

The decoder network 22 restores the scene graph 302 from the feature quantity 30 (step S14). In one example, the decoder network 22 restores output data corresponding to the scene graph 302 from the feature quantity 30.

The error calculation unit 57 calculates a scene graph restoration error between the scene graph 300 input to the encoder network 21 of the autoencoder 20 and the restored scene graph 302 (step S15). In one example, the error calculation unit 57 calculates a difference between the data generated in step S12 for the scene graph 300 and the output data restored from the feature quantity 30.

The information processing apparatus 1 trains, through error back propagation, the two neural networks that are the encoder network 21 and the decoder network 22 (step S16).

The clustering unit 55 calculates a distance between the individual feature quantities 30 acquired based on the respective scene graphs 300 corresponding to the respective frame images 210 (step S17).

The cluster training data calculation unit 56 creates training data for the clustering unit 55 from cluster information to which the feature quantity 30 belongs. The clustering unit 55 calculates a clustering error that is an error in the distance, from the cluster information to which the feature quantity 30 belongs (step S18). In one example, in a case where the clustering unit 55 calculates a distance between the feature quantities, the clustering unit 55 sets “0” if the scene graphs 300 for which the respective feature quantities are calculated belong to an identical scene (identical cluster) and sets “1” if the scene graphs 300 for which the respective feature quantities are calculated belong to different scenes (different clusters). The error calculation unit 57 may calculate the error by adding the scene graph restoration error and the clustering error together.

The processing of steps S17 and S18 may be omitted. In this case, the information processing apparatus 1 does not perform the processing of steps S17 and S18. The information processing apparatus 1 itself does not have to generate the scene graphs 300, and may receive the scene graphs 300 from another apparatus. In this case, step S11 is omitted.

If the processing is not completed for all the frame images (see NO route in step S19), the process returns to step S13 and the processing is performed for the next frame image 210.

On the other hand, if the processing is completed for all the frame images (see YES route in step S19), the training process ends, and a training process for another piece of moving image data 200 is started as appropriate.

### [B-2-2] At Time of Inference

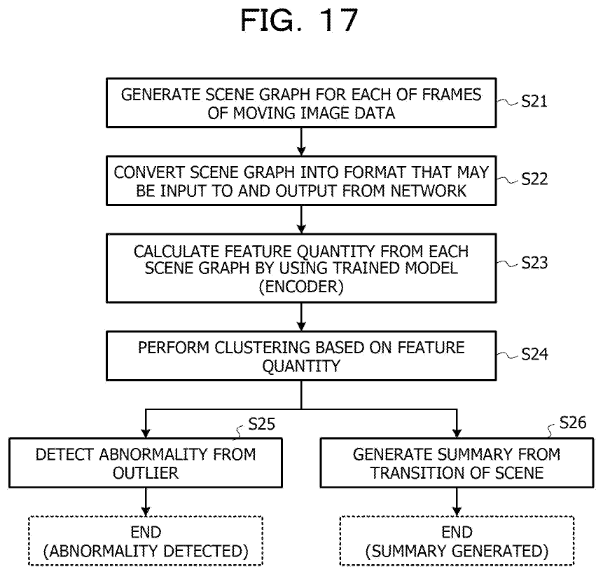

An inference process performed in the information processing apparatus 1 illustrated in FIG. 2 will be described in accordance with a flowchart (steps S21 to S26) illustrated in FIG. 17.

Processing in steps S21 and S22 are substantially the same as the processing in steps S11 and S12 in FIG. 16, respectively.

By using the trained model, the information processing apparatus 1 calculates the feature quantity 30 from each scene graph 300 (step S23). For example, a vectorization model in the encoder network 21 is trained through self-supervised machine learning. The processing in step S23 is an example of processing of acquiring, through machine learning in which the generated data serves as input data to the autoencoder 20, a feature quantity for the input data.

Based on the acquired feature quantity, the clustering unit 58 performs clustering (classification) of the image data (step S24). A clustering result may be used for various kinds of processing.

Based on an outlier of the feature quantity 30, the abnormality detection unit 61 may perform the abnormality detection process (step S25). The inference process then ends.

Based on the classification of the frame images 210, the summary generation unit 62 may perform the processing of creating a moving image summary in which moving image contents are summarized in time series (step S26). The inference process then ends. The summary generation unit 62 classifies the plurality of frame images 210 into a plurality of scenes based on the clustering result. By thinning out the image data in accordance with the transition of the scene, the summary generation unit 62 may create a moving image summary in which the moving image contents are summarized.

Both of or either one of the processing of step S25 and the processing of step S26 may be omitted. The information processing apparatus 1 itself does not have to generate the scene graphs 300, and may receive the scene graphs 300 from another apparatus. In this case, step S21 is omitted.

### [C] Effects

According to one example of the embodiment described above, for example, the following operation effects may be achieved.

The scene graph conversion unit 52 generates the data 340 in which, to each piece of word information included in the scene graph 300 that represents the plurality of target objects 211 in image data and a relationship between the plurality of target objects 211, information that indicates a relationship to which the piece of word information belongs and information that indicates a role of the piece of word information in the relationship are added. The feature quantity calculation unit 53 acquires, through machine learning in which the generated data 340 serves as input data to the autoencoder 20, the feature quantity 30 for the input data. The clustering unit 55 classifies the image data, based on the acquired feature quantity 30.

Thus, the feature quantity 30 may be acquired based on the scene graph 300 and the image data may be classified based on the feature quantity 30. Therefore, the image data may be classified based on not only the target objects appearing in the image data but also the relationship. As compared with a case where each frame image 210 is classified based on the feature quantity obtained from the frame image 210 itself, an influence of a color tone and an imaging condition of each frame image 210 may be reduced. Therefore, the contents of the scene including the target objects appearing in each frame image 210, the actions of the target objects, the relationship between the target objects, and the like may be accurately reflected in the feature quantity 30.

The image data represents the plurality of frame images 210 included in moving image data. The clustering unit 55 reduces a distance between the feature quantities 30 acquired based on the respective scene graphs 300 corresponding to respective frame images classified into an identical scene among the plurality of frame images 210. The clustering unit 55 increases a distance between the feature quantities 30 acquired based on the respective scene graphs 300 corresponding to respective frame images classified into different scenes among the plurality of frame images 210.

Thus, training may be performed to optimize the distance between the individual feature quantities 30. Therefore, the accuracy of the feature quantities 30 may be improved.

The first encoder 41 performs the first encoding processing of acquiring a piece of word information for one target object among the plurality of target objects 211. The second encoder 42 performs, based on a result of the first encoding processing, the second encoding processing of acquiring the information that indicates the relationship and the information that indicates the role. The third encoder 43 performs the third encoding processing of acquiring the feature quantity 30 by using the data generated based on the first encoding processing and the second encoding processing.

Thus, by inputting information included in the scene graph 300 in a hierarchical manner, the information may be transmitted to the autoencoder 20.

The information that indicates the role of the piece of word information includes subject information that indicates that the piece of word information corresponds to a subject, object information that indicates that the piece of word information corresponds to an object, and action information that indicates an action from the subject to the object.

Thus, the relationship between the individual pieces of word information may be reflected in the feature quantity 30.

Unlike the case where the two frame images 210 are compared with each other to determine whether or not the two frame images 210 represent the identical scene, clustering may be performed simultaneously for all the frame images 210 of the moving image data 200 in the process according to the present embodiment.

The data is created which is obtained by converting the scene graph 300 that has a format in which a plurality of pieces of data that are a target object that serves as a subject, a target object that serves as an object, and a relationship between the subject and the object are linked together, into a data format including the label token 341, the relationship token 342, and the type token 343. Thus, all the information included in the scene graph 300 may be transmitted to the autoencoder 20. With the data format including the label token 341, the relationship token 342, and the type token 343, the single feature quantity 30 may be obtained more easily, unlike the case where the scene graph 300 itself serves as the input data.

The feature quantity for the input data is acquired through self-supervised machine learning in which the generated data serves as the input data to the autoencoder 20. Thus, processing of calculating separate training data in advance is no longer to be performed, and a storage capacity for storing the training data may be reduced.

In a case of determining whether scenes of the two frame images 210 are identical by individually determining whether target objects in the images and a relationship therebetween are identical in the two frame images 210 and integrating the individual determination results together, an amount of calculation is O (m²) (where m denotes the number of target objects in a moving image). To perform the determination for all the frames, the same processing is repeated k² times (where k denotes the number of all the frames). Thus, the amount of calculation is O(m²×k²). By contrast, in the process according to the present embodiment, the target objects and the relationships are aggregated into a feature quantity that is a single vector. According to the present embodiment, the amount of calculation may be merely O(m+n) (where m denotes the number of target objects in the moving image and n denotes the number of relationships in the moving image). A specific value of O(m+n) depends on the encoder network 21. Since the amount of calculation of clustering of k feature quantities is O(k), the amount of calculation of the entire process is O(m+n)+O(k). Thus, with the process according to the present embodiment, the amount of calculation may be reduced.

The abnormality detection process may be performed based on an accurate clustering result in which contents of the scene including target objects appearing in image data, actions of the target objects, a relationship between the target objects, and the like are reflected. Thus, even if the appearing target objects themselves do not change, an abnormality may be detected from a change in the relationship.

The transition of the scene may be determined based on an accurate clustering result in which contents of the scene including target objects appearing in image data, actions of the target objects, a relationship between the target objects, and the like are reflected. Thus, a summary reflecting a more accurate situation may be created. In one example, through the summary generation process, a moving image summary may be created by collecting individual works performed in respective time slots from moving image data obtained by capturing an image of a work place such as a factory. For example, even in different works, the target objects appearing in the image data may not change. With the summary creation process according to the present embodiment, even if the appearing target objects do not change, since the change in the relationship between the target objects is reflected in the feature quantity 30, the moving image summary may be created with the transition of the scene being accurately grasped.

### [D] Others

The disclosed technique is not limited to the embodiment described above, and may be carried out by variously modifying the technique within a range not departing from the gist of the present embodiment. Each of the configurations and each of the processes of the present embodiment may be selectively employed or omitted as desired or may be combined as appropriate.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an information processing program for causing a computer to execute a process comprising:
generating data in which, to each piece of word information included in a graph that represents a plurality of target objects in image data and a relationship between the plurality of target objects, information that indicates a relationship to which the piece of word information belongs and information that indicates a role of the piece of word information in the relationship are added;
acquiring, through machine learning in which the generated data serves as input data to an autoencoder, a feature quantity for the input data; and
performing classification of the image data, based on the acquired feature quantity.

2. The non-transitory computer-readable recording medium according to claim 1, wherein
the image data represents a plurality of frame images included in moving image data,
the process further comprising:
reducing, in the machine learning, a distance between the feature quantities acquired based on the respective graphs that correspond to respective frame images classified into an identical scene among the plurality of frame images; and
increasing, in the machine learning, a distance between the feature quantities acquired based on the respective graphs that correspond to respective frame images classified into different scenes among the plurality of frame images.

3. The non-transitory computer-readable recording medium according to claim 1, wherein in the generating of the data,
performing first encoding processing of acquiring the piece of word information for one target object among the plurality of target objects, and
performing, based on a result of the first encoding processing, second encoding processing of acquiring the information that indicates the relationship and the information that indicates the role, and
wherein in the acquiring of the feature quantity,
performing third encoding processing of acquiring the feature quantity by using the data generated based on the first encoding processing and the second encoding processing.

4. The non-transitory computer-readable recording medium according to claim 1, wherein
the information that indicates the role includes subject information that indicates that the piece of word information corresponds to a subject, object information that indicates that the piece of word information corresponds to an object, and action information that indicates an action from the subject to the object.

5. An information processing apparatus comprising:
a memory, and
a processor coupled to the memory and configured to:
generate data in which, to each piece of word information included in a graph that represents a plurality of target objects in image data and a relationship between the plurality of target objects, information that indicates a relationship to which the piece of word information belongs and information that indicates a role of the piece of word information in the relationship are added;
acquire, through machine learning in which the generated data serves as input data to an autoencoder, a feature quantity for the input data; and
perform classification of the image data, based on the acquired feature quantity.

6. The information processing apparatus according to claim 5, wherein
the image data represents a plurality of frame images included in moving image data, and
the process is further configured to:
reduce, in the machine learning, a distance between the feature quantities acquired based on the respective graphs that correspond to respective frame images classified into an identical scene among the plurality of frame images; and
increase, in the machine learning, a distance between the feature quantities acquired based on the respective graphs that correspond to respective frame images classified into different scenes among the plurality of frame images.

7. The information processing apparatus according to claim 5, wherein the processor is configured to generate the data by:
performing first encoding processing of acquiring the piece of word information for one target object among the plurality of target objects, and
performing, based on a result of the first encoding processing, second encoding processing of acquiring the information that indicates the relationship and the information that indicates the role, and
the processor is configured to acquire the feature quantity by performing third encoding processing of acquiring the feature quantity by using the data generated based on the first encoding processing and the second encoding processing.

8. The information processing apparatus according to claim 5, wherein
the information that indicates the role includes subject information that indicates that the piece of word information corresponds to a subject, object information that indicates that the piece of word information corresponds to an object, and action information that indicates an action from the subject to the object.

9. An information processing method performed by a computer, the method comprising:
generating data in which, to each piece of word information included in a graph that represents a plurality of target objects in image data and a relationship between the plurality of target objects, information that indicates a relationship to which the piece of word information belongs and information that indicates a role of the piece of word information in the relationship are added;
acquiring, through machine learning in which the generated data serves as input data to an autoencoder, a feature quantity for the input data; and
performing classification of the image data, based on the acquired feature quantity.

10. The information processing method according to claim 9, wherein
the image data represents a plurality of frame images included in moving image data,
the method further comprising:
reducing, in the machine learning, a distance between the feature quantities acquired based on the respective graphs that correspond to respective frame images classified into an identical scene among the plurality of frame images; and
increasing, in the machine learning, a distance between the feature quantities acquired based on the respective graphs that correspond to respective frame images classified into different scenes among the plurality of frame images.

11. The information processing method according to claim 9, wherein in the generating of the data,
performing first encoding processing of acquiring the piece of word information for one target object among the plurality of target objects, and
performing, based on a result of the first encoding processing, second encoding processing of acquiring the information that indicates the relationship and the information that indicates the role, and
wherein in the acquiring of the feature quantity,
performing third encoding processing of acquiring the feature quantity by using the data generated based on the first encoding processing and the second encoding processing.

12. The information processing method according to claim 9, wherein
the information that indicates the role includes subject information that indicates that the piece of word information corresponds to a subject, object information that indicates that the piece of word information corresponds to an object, and action information that indicates an action from the subject to the object.
